(19) United States
(12) Patent Application Publication
(10) Pub. No.: US 2026/0336713 A1
(43) Pub. Date: Oct. 29, 2026

(54) COWL CROSS BAR

(71) Applicants: HYUNDAI MOTOR COMPANY, Seoul (KR); KIA CORPORATION, Seoul (KR); HYUNDAI MOBIS CO., LTD., Seoul (KR)

(72) Inventors: Min Ha Lee, Hwaseong-si (KR); Jae Hyun An, Hwaseong-si (KR); Ik Keun Choi, Yongin-si (KR); Young Jin You, Yongin-si (KR)

(73) Assignees: HYUNDAI MOTOR COMPANY, Seoul (KR); KIA CORPORATION, Seoul (KR); HYUNDAI MOBIS CO., LTD., Seoul (KR)

(21) Appl. No.: 19/370,260

(22) Filed: Oct. 27, 2025

(30) Foreign Application Priority Data
Apr. 28, 2025 (KR) 10-2025-0055549

(51) Int. Cl. B62D 25/08

(52) U.S. Cl. CPC B62D 25/081

(57) ABSTRACT

A cowl cross bar includes a main pipe and a support pipe coupled to each other and forming a supporting structure through a connecting part. Coupling rigidity is increased and fabrication and management thereof are efficiently performed by the cowl cross bar having a relatively light weight.

### CROSS REFERENCE TO RELATED APPLICATION

The present application claims priority to Korean Patent Application No. 10-2025-0055549, filed Apr. 28, 2025, the entire contents of which are incorporated herein for all purposes by this reference.

### BACKGROUND

### Technical Field

The present disclosure relates to a cowl cross bar that achieves light weight, is fabricated and managed efficiently, and ensures rigidity.

### Description of the Related Art

A body of a vehicle typically consists of a side frame and a number of cross beams that connect the side frame transversely.

Among the cross beams, a cowl cross beam is a structure that is installed transversely at a passenger compartment behind a cowl panel to provide rigidity to a front part of the vehicle body. The cowl cross beam supports a steering column and is designed to be sufficiently rigid to absorb vibration transmitted from the steering column.

At a lower portion of a center portion of the cowl cross beam, a support leg is coupled thereto to support the cowl cross beam. The support leg serves to distribute vibration from a steering device to a lower part of the vehicle body.

Meanwhile, a support leg, a side connector, and various brackets that are coupled to the cowl cross beam are produced by pressing, extrusion, casting, etc., and then coupled to the cowl cross beam by welding.

This increases the fabrication process, adds weight due to separate welding, and limits the ability to achieve reliable rigidity due to torn welds.

The subject matter described above as background technology is intended to provide a better understanding of the context of the present disclosure. The subject matter is not intended to constitute a disclaimer of the prior art known to those of ordinary skill in the art.

### SUMMARY

An objective of the present disclosure is to provide a cowl cross bar that achieves light weight, is fabricated and managed efficiently, and ensures rigidity.

The technical problems to be addressed or resolved in the present disclosure are not limited to the above technical problems. Other problems not mentioned herein should be more clearly understood by those of ordinary skill in the art from the description below.

In order to achieve the above objectives, a cowl cross bar is provided according to an embodiment of the present disclosure. The cowl cross bar includes a main pipe to be disposed laterally at a cowl of a vehicle and having a matching part formed at a portion of a lower end thereof. The cowl cross bar also includes a support pipe having a coupled part formed to match the matching part of the main pipe. The support pipe is configured to support the main pipe when coupled to the main pipe. The cowl cross bar further includes a connecting part providing a supporting structure while being brought into contact with the matching part and the coupled part. The connecting part may be provided at each of the matching part and the coupled part and have a supporting surface in a direction in which the matching part and the coupled part match each other.

In an embodiment, the main pipe may include a first channel part with a sectional shape protruding to be curved forward and may include a second channel part extending to protrude rearward from a lower portion of the first channel part. The matching part may be provided at a lower end of the second channel part.

In an embodiment, a sectional shape of the coupled part of the support pipe may include a front wall at a central portion and a side wall bent rearward from an end of the front wall.

In an embodiment, the connecting part may include a first supporting end extending from the matching part and in contact with opposite ends of the front wall of the coupled part, without a central portion, and the side wall.

In an embodiment, the first supporting end may extend forward from the matching part.

In an embodiment, the matching part may include a rib part connected to an upper surface of the first supporting end and supporting the first supporting end.

In an embodiment, the connecting part may include a second supporting end extending from a central portion of the front wall of the coupled part and in contact with the matching part.

In an embodiment, the second supporting end may extend rearward from the front wall of the coupled part.

In an embodiment, a sectional shape of the support pipe may include a front wall at a central portion and a side wall bent rearward from an end of the front wall. A lower portion of the front wall or the side wall may be closed to form or define a double flange part so that the cowl cross bar may be fixed to a vehicle body with the flange part.

In an embodiment, a reinforcing plate may be provided at front surfaces or rear surfaces of the matching part of the main pipe and the coupled part of the support pipe. The reinforcing plate may be fixed to the support pipe using a fastening member.

Meanwhile, a cowl cross bar is provided according to another embodiment of the present disclosure. The cowl cross bar includes a main pipe to be disposed laterally at a cowl of a vehicle and having a matching part formed at a portion of a lower end thereof. The cowl cross bar also includes a support pipe having a coupled part formed to match the matching part of the main pipe. The support pipe is configured to support the main pipe when coupled to the main pipe. The cowl cross bar further includes a connecting part providing a supporting structure and in contact with the matching part and the coupled part. The connecting part may be formed to partially cover the matching part and the coupled part and couple the matching part and the coupled part to each other.

In an embodiment, the main pipe may include a first channel part with a sectional shape protruding to be curved forward and may include a second channel part extending to protrude rearward from a lower portion of the first channel part. The matching part may be provided at a lower end of the second channel part.

In an embodiment, the connecting part may include a first supporting part disposed in front of the main pipe and the support pipe and may be inserted into or received in a front recessed portion formed with the second channel part protruding rearward. The connecting part may also include a second supporting part extending downward from the first supporting part and in contact with a front surface of the support pipe.

In an embodiment, the first supporting part of the connecting part may have a closed section and a reinforcing part may be formed to extend vertically in the first supporting part.

In an embodiment, with the first supporting part of the connecting part inserted into or received in the second channel part, a first fastening member may be fixed to the first supporting part through the first channel part and a second fastening member may be fixed to the support pipe through the second supporting part.

According to the cowl cross bar embodiments of the present disclosure, the main pipe and the support pipe are coupled to each other with the supporting structure formed through the connecting part. This increases the coupling rigidity, and the light weight of the cowl cross bar facilitates manufacturing and management thereof.

The effect of the present disclosure is not limited to the above-mentioned effects. Other effects not mentioned herein should be more clearly understood by those of ordinary skill in the art from the description below.

### BRIEF DESCRIPTION OF THE DRAWINGS

FIG. 1 is a view showing a cowl cross bar according to an embodiment of the present disclosure.

FIG. 2 is a view showing a matching part of a main pipe of the cowl cross bar shown in FIG. 1.

FIG. 3 is a sectional view showing the matching part of the main pipe of the cowl cross bar shown in FIG. 1.

FIG. 4 is a view showing a connecting part according to the cowl cross bar shown in FIG. 1.

FIG. 5 is a view showing a coupled part of a support pipe of the cowl cross bar shown in FIG. 1.

FIG. 6 is a sectional view showing the coupled part of the support pipe of the cowl cross bar shown in FIG. 1.

FIG. 7 is a view showing a connection between the main pipe and the support pipe of the cowl cross bar shown in FIG. 1.

FIG. 8 is a view showing a connection between the support pipe and a vehicle body according to the embodiment of the present disclosure.

FIG. 9 is a view showing a reinforcing plate according to the embodiment of the present disclosure.

FIG. 10 is a view showing a cowl cross bar according to another embodiment of the present disclosure.

FIG. 11 is a sectional view showing a main pipe, a support pipe, and a connecting part of the cowl cross bar shown in FIG. 10.

FIG. 12 is a view showing a coupling of the main pipe, the support pipe, and the connecting part of the cowl cross bar shown in FIG. 10.

### DETAILED DESCRIPTION OF THE DISCLOSURE

In describing embodiments disclosed in the present disclosure, where it has been determined that the detailed description of the related art would have obscured the gist of the present disclosure, the detailed description thereof has been omitted. In addition, the accompanying drawings are merely intended to be able to readily understand the embodiments disclosed herein. Thus, the technical ideas disclosed herein are not limited by the accompanying drawings. It should be understood that the disclosed embodiments include all changes, equivalents, and substitutions included in the ideas and technical scope of the present disclosure. The following description is not intended to limit the present disclosure to the precise forms or particular fields of use disclosed. It is contemplated that various alternative embodiments and modifications to the present disclosure are possible, whether explicitly set forth or implied herein. A person of ordinary skill in the art should recognize that changes may be made in form and detail without departing from the scope of the present disclosure.

The present disclosure is described with reference to specific embodiments. However, as should be appreciated by one of ordinary skill in the art to which the present disclosure pertains, various embodiments disclosed herein can be modified or otherwise implemented in various other ways without departing from the spirit and scope of the present disclosure. Accordingly, the following description is to be considered illustrative and is for the purpose of teaching those of ordinary skill in the art the manner of making and using various embodiments. It is to be understood that the forms of disclosure herein shown and described are to be taken as representative embodiments. Equivalent elements, materials, processes, or steps may be substituted for those representatively illustrated and described herein. Expressions such as “including”, “comprising”, “incorporating”, “consisting of”, “have”, “is”, and the like, and variations thereof, used to describe and claim the present disclosure are intended to be construed in a non-exclusive manner, namely allowing for items, components, or elements not explicitly described also to be present. Additionally, reference to the singular is also to be construed to relate to the plural.

Further, various embodiments disclosed herein are to be taken in the illustrative and explanatory sense and should in no way be construed as limiting of the present disclosure. All joining references (e.g., attached, affixed, coupled, connected, and the like) are only used to aid the reader's understanding of the present disclosure, and may not create limitations, particularly as to the position, orientation, or use of the elements and/or methods disclosed herein. Therefore, joining references, if any, are to be construed broadly. Moreover, such joining references do not necessarily infer that two elements are directly connected to each other. Additionally, all numerical terms or expressions, such as, but not limited to, “first”, “second”, “third”, “primary”, “secondary”, “main”, or any other ordinary and/or numerical terms, should also be taken only as identifiers, to assist the reader's understanding of the various elements, embodiments, variations and/or modifications of the present disclosure. Such terms or expressions may not create any limitations, particularly as to the order, or preference, of any element, embodiment, variation, and/or modification. In other words, these expressions can be used to describe various elements, but the elements are not limited by these expressions. These expressions are only used to distinguish one element from another element.

The suffixes “module” and “part” used in the following description are given or mixed together only considering the ease of creating the specification. These suffixes have no meanings or roles that are distinguished from each other by themselves.

It should be understood that, when an element is referred to as being “coupled” or “connected” to another element, it can be directly coupled or connected to the other element or intervening elements may be present therebetween. In contrast, it should be understood that, when an element is referred to as being “directly coupled” or “directly connected” to another element, there are no intervening elements present. Further, as used herein, “form”, “forming”, or “forms” may mean that an element defines, generates, creates, or otherwise yields a noted characteristic, trait, structure, or the like. Likewise, as used herein, “formed” may mean that an element is fabricated or manufactured to have a noted characteristic, trait, structure, or the like or may mean that an element is provided, located, disposed, positioned, or the like at or on a specified location.

Any number or variety of components in any of the configurations described herein may be included within the disclosure described herein. The components may include any combination of the features described herein and may be arranged in any of the various configurations described herein. The concepts regarding the structure and arrangement of the components of the present disclosure, as well as their use and operation, may be applied not only to the specific embodiments discussed herein, but to any number of embodiments in any combination. Embodiments including those having various features in various arrangements are described below with reference to the drawings.

Hereinafter, various embodiments presented in the present disclosure are described in detail with reference to the accompanying drawings. Identical or similar elements in the drawings are given the same reference numerals throughout the drawings, and repeated description thereof has been omitted. When a component, module, unit, portion, part, member, element, apparatus, or the like of the present disclosure is described as having a purpose or performing an operation, function, or the like, the component, module, unit, portion, part, member, element, apparatus, or the like should be considered herein as being “configured to” meet that purpose or to perform that operation or function.

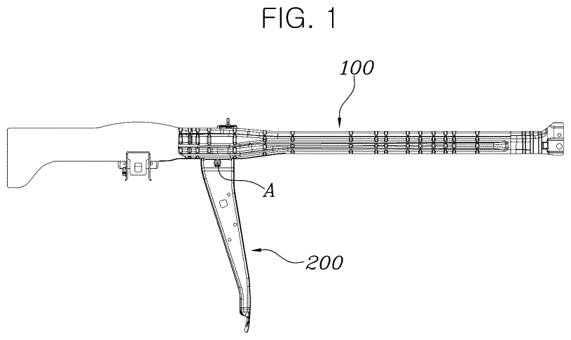

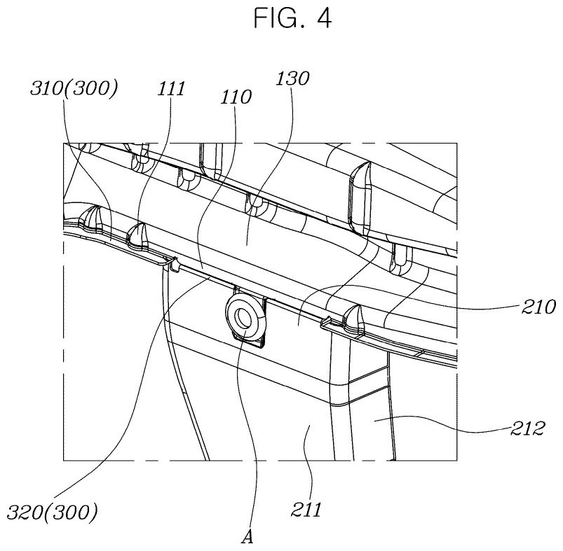

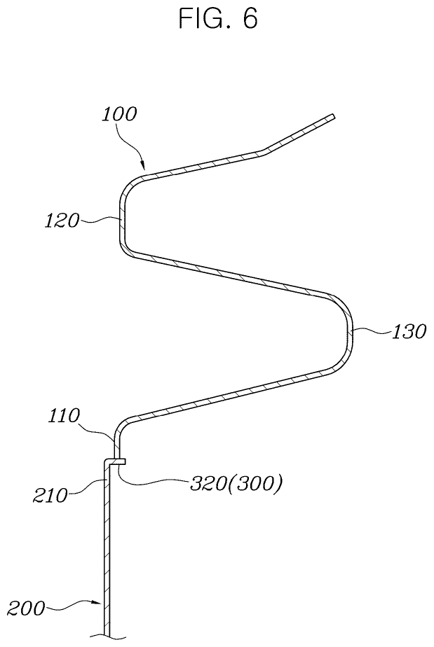

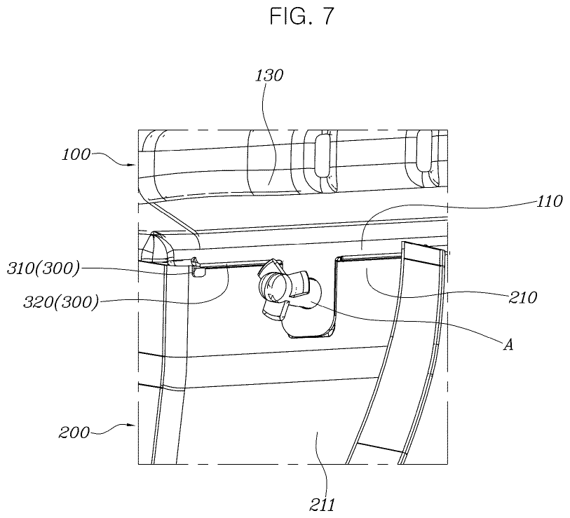

According to an embodiment of the present disclosure, as shown in FIGS. 1-7, a cowl cross bar may include: a main pipe 100 (bar, beam, structure, etc.) that is configured to be disposed laterally at a cowl of a vehicle, and including a matching part 110 formed at a portion of a lower end thereof; a support pipe 200 (bar, beam, structure, etc.) including a coupled part 210 formed to match the matching part 110 of the main pipe 100, the support pipe 200 supporting the main pipe 100 when being coupled to the main pipe 100; and a connecting part 300 forming a supporting structure while being brought into contact with the matching part 110 and the coupled part 210.

The main pipe 100 and the support pipe 200 may be made of a steel material and made of a composite material including carbon fiber or glass fiber that is relatively light in comparison to a metal material. In addition, the material used in the main pipe 100 and the support pipe 200 may include aluminum. A variety of materials may be used to secure their rigidity and reduce the weight.

The main pipe 100 may be fixed to a side portion of a vehicle body B. The support pipe 200 may be connected to the main pipe 100 while being connected to the vehicle body B and support the main pipe 100.

The main pipe 100 may be disposed laterally at the cowl of the vehicle and may include the matching part 110 to achieve coupling with the support pipe 200.

The support pipe 200 may include the coupled part 210 and the coupled part 210 may be formed at an upper end of the support pipe 200.

In other words, the matching part 110 is formed at the lower end of the main pipe 100 and the coupled part 210 is formed at the upper end of the support pipe 200. As the matching part 110 and the coupled part 210 are brought into contact with each other, the main pipe 100 and the support pipe 200 may be coupled to each other. The matching part 110 and the coupled part 210 may be coupled to each other by welding, bolting, riveting, or the like.

In the present disclosure, the matching part 110 and the coupled part 210 may include the connecting part 300. The connecting part 300 may be formed at each of or one of the matching part 110 and the coupled part 210 and may include a supporting surface disposed or arranged in a direction in which the matching part 110 and the coupled part 210 match each other.

In the present disclosure, the connecting part 300 may be formed at each of the matching part 110 and the coupled part 210 and may include or consist of a supporting surface to provide an additional support structure to a contact area of the matching part 110 and the coupled part 210. This may ensure supporting rigidity with respect to an axial direction.

In describing in detail the present disclosure, the main pipe 100 may include a first channel part 120 having a sectional shape protruding to be curved forward, i.e., curved or convex in a forward direction, and may include a second channel part 130 extending or arranged to protrude downward from or below a lower portion of the first channel part 120 and having a section shape protruding to be curved rearward, i.e., curved or convex in an opposite rearward direction. The matching part 110 may be formed at a lower end of the second channel part 130. At this point, the section may be a side section.

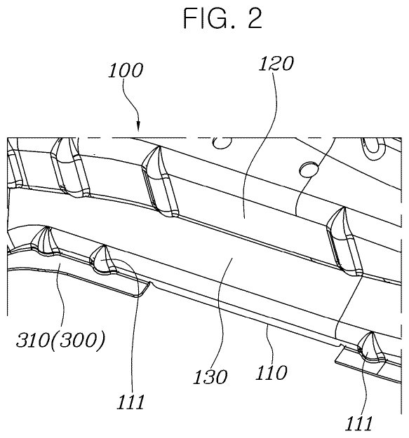

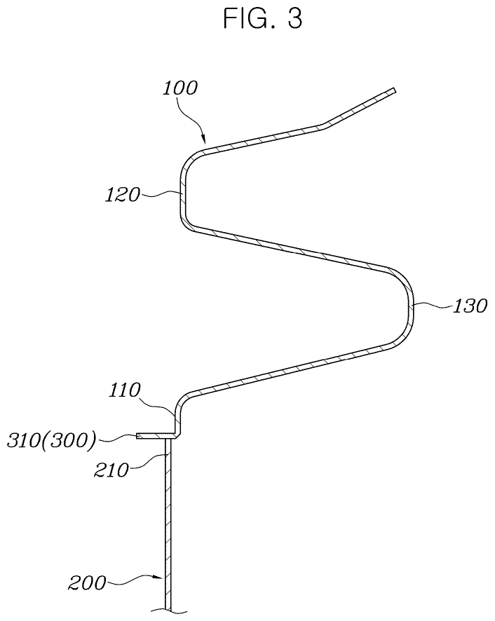

As shown in FIG. 2 and FIG. 3, the main pipe 100 may have an ‘S’ shape with the first channel part 120 and the second channel part 130 formed to protrude alternately in a front-rear direction. As described above, the main pipe 100 may ensure overlapping performance in response to a frontal impact, as the first channel part 120 and the second channel part 130 provide a forward-rearward curved shape.

The forward-rearward curved shape consisting of the first channel part 120 and the second channel part 130 may be formed opposite to each other. Furthermore, in addition to the first channel part 120 and the second channel part 130, another channel part may be provided. Each channel part may have different shapes in response to required rigidity and the design of the vehicle body B.

The matching part 110 may be formed at the second channel part 130 located at the lower portion of the main pipe 100. The matching part 110 provided at the lower end of the second channel part 130 may allow the coupled part 210 of the support pipe 200 to be coupled to the matching part 110. In other words, the matching part 110 may be a portion of the second channel part 130 and may have a shape cut in response to the shape of the coupled part 210 of the support pipe 200.

A sectional shape of the coupled part 210 of the support pipe 200 may include a front wall 211 at a central portion and a side wall 212 bent rearward from an end or both ends of the front wall 211. At this point, the section may be an upper cross-section view.

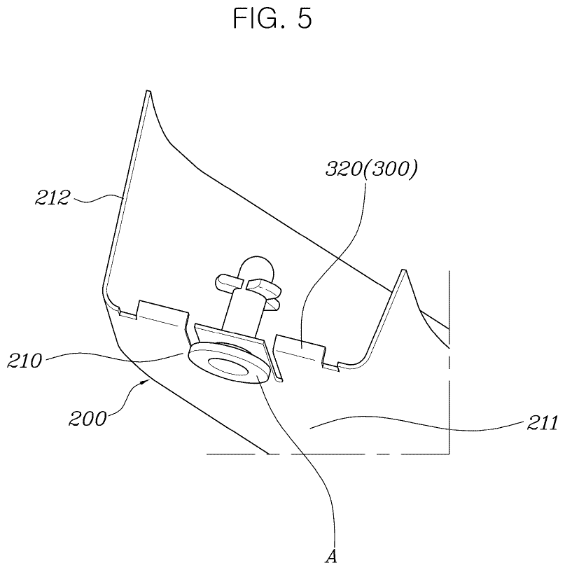

As shown in FIG. 5, the coupled part 210 of the support pipe 200 may be formed in a ‘[’-shape, i.e., a ‘C’-like shape or a ‘U’-like shape while being formed by the front wall 211 and the side wall or walls 212. The front wall 211 and the side walls 212 may provide not only the shape of the coupled part 210 but also the overall shape of the support pipe 200.

Accordingly, the support pipe 200 may ensure overlapping performance in response to a frontal impact, as the front wall 211 and the side walls 212 provide the curved shape of the support pipe 200. Furthermore, the support pipe 200 ensures contact rigidity, as both the front wall 211 and the side walls 212 come into contact with the matching part 110 of the main pipe 100, thereby creating a contact area.

The coupled part 210 is formed at the upper end of the support pipe 200 to be coupled to the matching part 110 of the main pipe 100.

The connecting part 300, which ensures the coupling rigidity of the main pipe 100 and the support pipe 200 to each other, may include a first supporting end 310 and a second supporting end 320.

As shown in FIGS. 2-4, the first supporting end 310 may extend from the matching part 110 in a manner to be brought into contact with opposite ends of the front wall 211 of the coupled part 210 and the side walls 212, while not having a central part that would coincide with the portion of the front wall 211 between the opposite ends.

At this point, the first supporting end 310 may extend forward from the matching part 110.

The first supporting end 310 extending forward from the matching part 110 may be formed by a cut portion or a forward extending portion of the matching part 110.

As an example, the portion cut for forming the first supporting end 310 corresponds to a central portion of the front wall 211 of the coupled part 210. The first supporting end 310 may form a supporting structure while being brought into contact with opposite ends of the front wall 211 of the coupled part 210 and the side walls 212. For this reason, when the main pipe 100 and the support pipe 200 are coupled to each other, excessive load concentration on the front wall 211 of the coupled part 210 of the support pipe 200 is prevented, and longitudinal rigidity is ensured as the load is distributed.

Furthermore, the matching part 110 may include a rib part or parts 111 connected to or formed on an upper surface of the first supporting end 310 to support the first supporting end 310. Multiple rib parts 111 may be provided in a longitudinal direction of the main pipe 100. Rigidity of the first supporting end 310 may be increased with the second channel part 130 and the first supporting end 310 connected to each other.

As shown in FIGS. 5-7, the second supporting end 320 may extend from the central portion of the front wall 211 of the coupled part 210 to be brought into contact with the matching part 110.

At this point, the second supporting end 320 may extend rearward from the front wall 211 of the coupled part 210.

As described above, the second supporting end 320 extends rearward from the coupled part 210. A portion of the coupled part 210 may be folded rearward to form the second supporting end 320. At this point, a portion to be folded to form the second supporting end 320 may be the central portion of the front wall 211 of the coupled part 210. The second supporting end 320 is brought into contact with the lower end of the second channel part 130 of the main pipe 100 to form a support structure. The second supporting end 320 may be provided to be divided into multiple second supporting ends.

Accordingly, when the main pipe 100 and the support pipe 200 are coupled to each other, the support pipe 200 may support the main pipe 100, the first supporting end 310 of the main pipe 100 is brought into contact with the opposite ends of the front wall 211 of the coupled part 210 and the side walls 212 to form the support structure, and the second supporting end 320 of the support pipe 200 is brought into contact with the main pipe 100 at the central portion of the front wall 211 to form the support structure. This ensures the rigid support structure of the main pipe 100 and the support pipe 200. Also, rigidity securement and vibration damping can be achieved without the need for separate parts.

A sectional shape of the support pipe 200 includes the front wall 211 at a central portion and the side walls 212 bent rearward from the opposed ends or edges of the front wall 211. A lower portion of the front wall 211 or the side walls 212 may be closed to form the double flange part 220 so that the support pipe 200 may be fixed to the vehicle body B through the flange part 220.

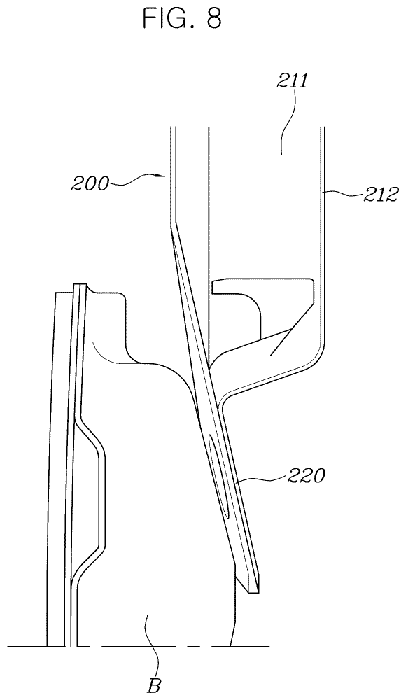

As shown in FIG. 8, while the front wall 211 and the side walls 212 are gathered, a lower portion of the support pipe 200 may form the double flange part 220.

The flange part 220 may be formed from the lower portion of the front wall 211 deformed to be brought into contact with one of the side walls 212, or a lower portion of one of the side walls 212 may be deformed to be brought into contact with the front wall 211, so that the front wall and the one side wall have the same surface. In another example, the two side walls 212 on the sides of the front wall 211 can be brought into contact with one another and the width of the front wall 211 therebetween can be diminished in order to form the double flange part 220.

The flange part 220 has the rigidity thereof as the front wall 211 and the side wall 212 overlap each other to form the double structure. A portion to be coupled to the vehicle body B is provided only with the flange part 220, whereby the support pipe 200 is fixed to the vehicle body B without a separate part. The flange part 220 may be formed into a trio structure with the front wall 211 and a pair of side walls 212 overlapping each other, which may be variously applied according to the design thereof.

A fastening member A may penetrate the flange part 220 so that the support pipe 200 may be fixed to the vehicle body B. The fastening member A may be configured so that the parts are fastened by bolting or riveting.

Furthermore, the flange part 220 may form an additional overlap structure by changing the overlap shape of the front wall 211 and the side wall 212. The overlap shape may be changed according to a required rigidity when the support pipe 200 is fixed to the vehicle body B.

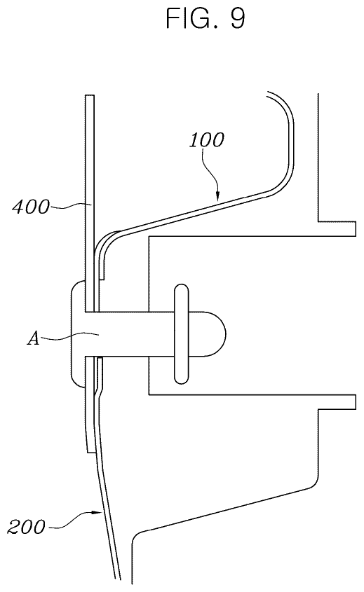

As shown in FIG. 9, a reinforcing plate 400 may be provided at front surfaces or rear surfaces of the matching part 110 of the main pipe 100 and the coupled part 210 of the support pipe 200. The reinforcing plate 400 may be fixed to the support pipe 200 through the fastening member A. At this point, the fastening member A may be a bolt or a rivet.

The reinforcing plate 400 may be provided at one or both of the front and rear surfaces of the main pipe 100 and the support pipe 200 and may be formed to cover a portion in which the main pipe 100 and the support pipe 200 are coupled to each other.

The reinforcing plate 400 may be made of a rigid body and, as it covers the coupled portion of the main pipe 100 and the support pipe 200, absorb an external impact generated from the portion. The reinforcing plate 400 may be coupled to the main pipe 100 and the support pipe 200 through the fastening member A to increase the coupling rigidity of the main pipe 100 and the support pipe 200.

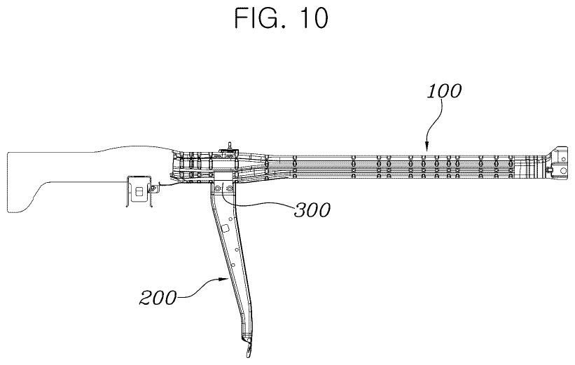

According to another embodiment of the present disclosure, as shown in FIGS. 10-12, the cowl cross bar may include: the main pipe 100 disposed laterally at the cowl of the vehicle, and including the matching part 110 at a portion of the lower end; the support pipe 200 including the coupled part 210 matching the matching part 110 of the main pipe 100, and supporting the main pipe 100 when being coupled to the main pipe 100; and the connecting part 300 providing the supporting structure while being brought into contact with the matching part 110 and the coupled part 210.

The main pipe 100 may be fixed to a side portion of a vehicle body B. The support pipe 200 may be connected to the main pipe 100, while being connected to the vehicle body B, and support the main pipe 100.

The main pipe 100 is disposed laterally at the cowl of the vehicle and may include the matching part 110 to achieve coupling with the support pipe 200.

The support pipe 200 may include the coupled part 210, and the coupled part 210 may be formed at an upper end of the support pipe 200.

In other words, the matching part 110 is formed at the lower end of the main pipe 100 and the coupled part 210 is formed at the upper end of the support pipe 200. As the matching part 110 and the coupled part 210 are brought into contact with each other, the main pipe 100 and the support pipe 200 may be coupled to each other. The matching part 110 and the coupled part 210 may be coupled to each other by welding, bolting, or riveting.

In the present disclosure, the matching part 110 and the coupled part 210 may be coupled to each other through the connecting part 300. The connecting part 300 may be formed to cover the matching part 110 and the coupled part 210 and fasten the matching part 110 and the coupled part 210 to each other.

As described above, the connecting part 300 may be formed to cover a contact portion of the matching part 110 and the coupled part 210 and may be fixed by being fastened to both the main pipe 100 and the support pipe 200. This ensures the coupling rigidity and ensures the axial supporting rigidity of the main pipe 100 and the support pipe 200.

Specifically, the main pipe 100 includes the first channel part 120 having a protruding sectional shape that is curved forward and includes the second channel part 130 extending from the lower portion of the first channel part 120 to protrude rearward. The matching part 110 may be formed at the lower end of the second channel part 130.

The main pipe 100 may have a ‘S’ shape as the first channel part 120 and the second channel part 130 are formed to protrude alternately in the front-rear direction. As described above, the main pipe 100 may ensure overlapping performance in response to a frontal impact, as the first channel part 120 and the second channel part 130 provide a forward-rearward curved shape.

The matching part 110 may be formed at the second channel part 130 located at the lower portion of the main pipe 100. The matching part 110 provided at the lower end of the second channel part 130 may allow the coupled part 210 of the support pipe 200 to be coupled to the matching part 110.

The connecting part 300 may include a first supporting part 330 disposed in front of the main pipe 100 and the support pipe 200 and inserted into a front recessed portion, i.e., the convex part, that is recessed as the second channel part 130 protrudes rearward. The connecting part 330 may also include a second supporting part 340 extending downward from the first supporting part 330 to be brought into contact with the front surface of the support pipe 200.

As described above, the connecting part 300 may include the first supporting part 330 and a second supporting part 340. The connecting part 300 may be formed such that the first supporting part 330 covers the main pipe 100 and the second supporting part 340 covers part of the support pipe 200.

The connecting part 300 is disposed in front of the main pipe 100. The first supporting part 330 may be inserted from the front space of the second channel part 130 into the second channel part 130. Accordingly, the first supporting part 330 may be formed to match the shape of the front portion recessed as the second channel part 130 protrudes rearward.

The second supporting part 340 may be disposed in front of the support pipe 200 and formed to cover the front surface of part of the support pipe 200.

As described above, the connecting part 300 may increase coupling rigidity of the matching part 110 and the coupled part 210, with the first supporting part 330 inserted into the second channel part 130 and covering the matching part 110 and the second supporting part 340 covering the coupled part 210 of the support pipe 200. The connecting part 300 may also protect the contact portion of the matching part 110 and the coupled part 210 from an impact or vibration.

Furthermore, the first supporting part 330 of the connecting part 300 has a closed section. The first supporting part 330 may include a reinforcing part 350 therein, the reinforcing part 350 extending vertically.

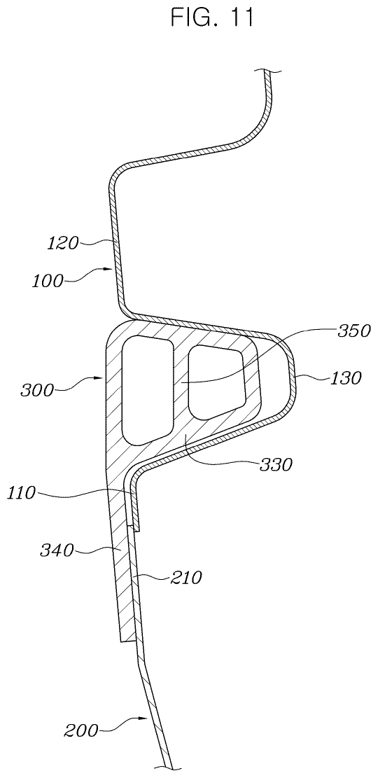

As shown in FIG. 11, the first supporting part 330 of the connecting part 300 has a closed section with a portion that protrudes for the first supporting part 330 to be inserted into the second channel part 130 and a portion that extends longitudinally from the second supporting part 340. The reinforcing part 350 is formed longitudinally inside the first supporting part 330 to increase rigidity thereof. The number of reinforcing parts 350 may be set differently according to required rigidity. Also, the reinforcing part 350 may be formed in a diagonal direction in addition to the longitudinal direction.

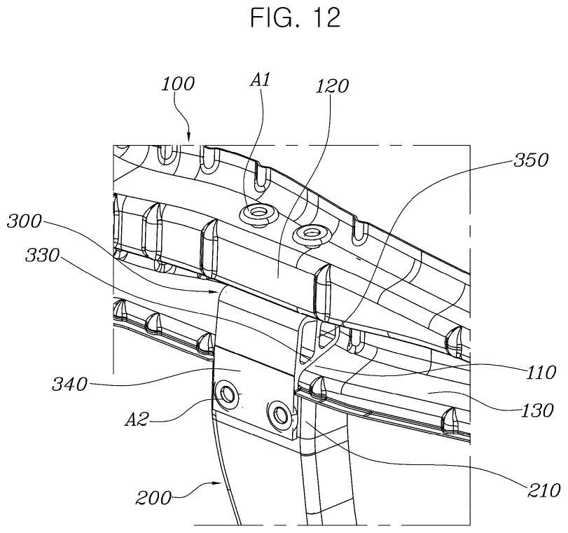

As shown in FIG. 12, the first supporting part 330 is inserted into the second channel part 130. A first fastening member A1 penetrates the first channel part 120 and is fixed to the first supporting part 330. A second fastening member A2 penetrates the second supporting part 340. Thus, the connecting part 300 may be fixed to the support pipe 200.

The first fastening member A1 and the second fastening member A2 may be bolts or rivets.

As described above, the first supporting part 330 is inserted into the second channel part 130 and covers the matching part 110 of the main pipe 100. The first fastening member A1 longitudinally penetrates the first channel part 120 to be fastened to the first supporting part 330. Thus, the first supporting part 330 of the connecting part 300 may be fixed to the main pipe 100. Furthermore, the second supporting part 340 covers the coupled part 210 of the support pipe 200. The second fastening member A2 penetrates the second supporting part 340 transversely to be fastened to the support pipe 200. Thus, the second supporting part 340 of the connecting part 300 may be fixed to the support pipe 200.

As described above, the connecting part 300 is fixed to the main pipe 100 and the support pipe 200 by longitudinal fastening of the first fastening member A1 and transverse fastening of the second fastening member A2. Rigid coupling is thereby maintained, and rigidity support is ensured in both the axial direction and the transverse direction.

According to the cowl cross bar of the present disclosure, the main pipe and the support pipe are coupled to each other with the supporting structure formed through the connecting part. This increases the coupling rigidity, and the light weight of the cowl cross bar facilitates manufacturing and management thereof.

Although specific embodiments of the present disclosure have been provided, it should be apparent to one of ordinary skill in the art that the present disclosure may be changed and modified in various ways without departing from the scope of the present disclosure, which is provided in the following claims.

What is claimed is:

1. A cowl cross bar comprising:
a main pipe configured to be disposed laterally at a cowl of a vehicle and including a matching part at a portion of a lower end thereof;
a support pipe including a coupled part that matches the matching part of the main pipe, the support pipe coupled to the main pipe to support the main pipe; and
a connecting part providing a supporting structure in contact with the matching part and the coupled part,
wherein the connecting part is provided at each of the matching part and the coupled part and has a supporting surface arranged in a direction in which the matching part and the coupled part match each other.

2. The cowl cross bar of claim 1, wherein the main pipe includes a first channel part with a curved sectional shape protruding forward and a second channel part extending to protrude rearward from a lower portion of the first channel part, and wherein the matching part is provided at a lower end of the second channel part.

3. The cowl cross bar of claim 1, wherein a sectional shape of the coupled part of the support pipe includes a front wall at a central portion and a side wall bent rearward from an end of the front wall.

4. The cowl cross bar of claim 3, wherein the connecting part includes a first supporting end extending from the matching part in contact with opposite ends of the front wall of the coupled part, without a central portion, and the side wall.

5. The cowl cross bar of claim 4, wherein the first supporting end extends forward from the matching part.

6. The cowl cross bar of claim 4, wherein the matching part includes a rib part connected to an upper surface of the first supporting end and supporting the first supporting end.

7. The cowl cross bar of claim 3, wherein the connecting part includes a second supporting end extending from a central portion of the front wall of the coupled part in contact with the matching part.

8. The cowl cross bar of claim 7, wherein the second supporting end extends rearward from the front wall of the coupled part.

9. The cowl cross bar of claim 1, wherein a sectional shape of the support pipe includes a front wall at a central portion and a side wall bent rearward from an end of the front wall, and wherein a lower portion of the support pipe is closed to define a double flange part configured to fix the cowl cross bar to a vehicle body with the flange part.

10. The cowl cross bar of claim 1, wherein a reinforcing plate is provided at front surfaces or rear surfaces of the matching part of the main pipe and the coupled part of the support pipe, and wherein the reinforcing plate is fixed to the support pipe via a fastening member.

11. A cowl cross bar comprising:
a main pipe configured to be disposed laterally at a cowl of a vehicle and including a matching part at a portion of a lower end thereof;
a support pipe including a coupled part that matches the matching part of the main pipe, the support pipe coupled to the main pipe to support the main pipe; and
a connecting part providing a supporting structure in contact with the matching part and the coupled part,
wherein the connecting part partially covers the matching part and the coupled part and couples the matching part and the coupled part to each other.

12. The cowl cross bar of claim 11, wherein the main pipe includes a first channel part with a curved sectional shape protruding forward and a second channel part extending to protrude rearward from a lower portion of the first channel part, and wherein the matching part is provided at a lower end of the second channel part.

13. The cowl cross bar of claim 12, wherein the connecting part comprises:
a first supporting part disposed in front of the main pipe and the support pipe and in a front recessed portion with the second channel part protruding rearward; and
a second supporting part extending downward from the first supporting part in contact with a front surface of the support pipe.

14. The cowl cross bar of claim 13, wherein the first supporting part of the connecting part has a closed section, and wherein a reinforcing part extends vertically in the first supporting part.

15. The cowl cross bar of claim 13, wherein:
the first supporting part of the connecting part is received in the second channel part;
a first fastening member is fixed to the first supporting part through the first channel part; and
a second fastening member is fixed to the support pipe through the second supporting part.
